(19) United States
(12) Patent Application Publication
(10) Pub. No.: US 2020/0170761 A1
(43) Pub. Date: Jun. 4, 2020

(54) Prefabricated Dental Impression Tray in a Modular System

(71) Applicant: Sebastian LINZEN, Mönchengladbach (DE)

(72) Inventor: Sebastian LINZEN, Mönchengladbach (DE)

(21) Appl. No.: 16/639,164

(22) PCT Filed: Aug. 24, 2018
(86) PCT No.: PCT/DE2018/100736

§ 371 Date: Feb. 14, 2020

(30) Foreign Application Priority Data
Aug. 24, 2017 (DE) 10 2017 119 448.7

(51) Int. Cl. A61C 9/00

(52) U.S. Cl. CPC A61C 9/0006

(57) ABSTRACT

A dental impression tray which in a modular system can be assembled from a plurality of portions which can be connected together and is thus individually adaptable to the patient jaw situation. There may be a universal base tray with insertable additional parts both for lower jaw and also for upper jaw impressions, wherein further adaptation can be implemented by extension portions and by shortening of the portions on the basis of predetermined markings or desired breaking locations. The impression tray may be a thermoplastic material which can be heated and still more precisely formed to the respective jaw geometry within the patient's mouth.

Many impressions in dental practice are made by means of so-called prefabricated trays. They usually consist of metal, hard plastic or silicone.

Those trays have some negative aspects, for example a risk of injury to the patient in the impression process. Furthermore the practitioner must always stock a large number of very different trays in the practice in order to be able to deal with the situation which arises individually in relation to a patient in the best possible way.

Firstly the large number of different tray (shapes) required will be considered: prefabricated trays are required in particular for:—
fully toothed jaws,
part-toothed (partially toothed) jaws,
toothless jaws, and
children's jaws.

Added thereto are also variants in which only “half trays”/so-called “part-trays” are used, which are required only for a given region of the dental arch (if the rest of the dental arch is not needed in creating the dental prosthesis). In that variant there are also in turn distinguishing factors, for example for the front tooth region, the side tooth region at the right, the side tooth region at the left, and so forth.

All those trays are on average usually stocked for each variant in five different sizes per jaw (top jaw and bottom jaw).

In addition it is generally not sufficient if the practitioner keeps only one tray of each variant in stock for it is certainly possible that a number of patients on one day in making impressions require the same tray (in respect of shape and size) or a tray which has actually already been used again still has to be sterilized and is therefore not available.

This consequently means that the practitioner must stock a large number of trays. If he keeps too few trays in stock or if a given tray which is actually required is not currently available then either the patient cannot be treated or it is necessary as an auxiliary measure to use a tray which does not entirely optimally fit, which is generally disadvantageous from the point of view of comfort aspects for the patient and also for later work in the dental laboratory.

In addition trays have to be re-ordered at regular intervals. There are various reasons for this: wear, loss (as the dental laboratory has not correctly returned them), and so forth.

The average price for a prefabricated tray at the present time is about 7 Euros. An ordinary dental practice stocks about 300 trays and in a practice selected by way of example about 80 trays had to be re-ordered each year.

Furthermore cleaning and sterilization of the used impression trays are a time- and cost-intensive procedure: in most cases the trays are provided with special adhesives before the impression is made so that an even better bond is produced between the tray base and the impression material. It will be appreciated that those adhesives have to be removed before sterilization. A relatively great amount of working time and possibly a relatively expensive cleaning agent is required for that purpose to remove the residues. If they are not adequately removed that can involve failures and repair costs in respect of the sterilization apparatus or thermal disinfector as blockage of the nozzles can occur.

Furthermore prefabricated trays take up a great deal of space in the sterilizer or thermal disinfector so that possibly a plurality of passes are required in order correctly to clean all dental materials and instruments, and that prolongs and complicates practice operations.

In addition the trays take up a comparatively large amount of storage space or storage area in the practice rooms. Typically the trays require a large drawer per treatment room and additional space in the sterilization room.

All in all prefabricated trays are decidedly work- and cost-intensive for the practitioner in regard to various aspects, in which case those “overheads” generally cannot be ascribed to the individual treatment.

The object of the present invention is to provide possible ways of significantly reducing the number of trays to be stocked and at the same time being able to adapt the prefabricated tray—prior to actual use—to the patient situation on a more individual basis.

The above-specified object is attained by means of a dental impression tray having the features of claim 1, by means of a component for such an impression tray as set forth in claim 14 and by means of a method having the features of claim 15.

Advantageous configurations of the invention are recited in the appendant claims.

According to the invention the impression tray can be assembled in a modular system from a plurality of parts or components which can be connected together and it can thus be individually adapted to the patient jaw situation.

Individual adaptability by assembly involving a modular system is intended to mean that a practitioner with knowledge of the individual patient jaw on which an impression is to be taken can select and assemble given components, more specifically generally extra-corporally, in which case then finally the suitably assembled tray can be used for the desired impressions.

With such a modular system the number of impression trays to be kept in stock can be significantly reduced and nonetheless optimum adaptation to the patient jaw can be achieved, which can possibly be even more finely graduated and thus better than in a system involving predetermined “full trays”.

Preferably the impression tray has a base tray which can be used equally both for the lower jaw and for the upper jaw and which can then be respectively supplemented and/or adapted by additional parts which can be connected.

Such a universal tray can also be referred to as a “unisex tray”—based on the language used inter alia in the fashion world—, although this obviously does not involve a gender-specific distinction.

In regard to the configuration of such a universal or unisex tray both for the upper jaw (UJ) and also for the lower jaw (LJ) the points in common and the differences of the previous upper jaw and lower jaw trays are to be taken into consideration:

In the case of a lower jaw tray the tongue space (interior in the tray) is free whereas in the case of an upper jaw tray there is a kind of “palate vault” to be found.

That fact previously prevents the dentist from taking an impression of a lower jaw with an upper jaw tray or vice-versa.

The outer edges (in other words: buccal) in contrast differ only marginally so that here a geometrical mean value can be used for upper and lower jaws.

According to the invention the specified differences can be taken into consideration by different additional elements which can be connected to a unitary base element.

It will be noted however that the invention is not limited in principle to a modular system having a universal base tray for upper and lower jaws.

In an alternative embodiment (not set forth in greater detail hereinafter) the modular system could also include from the outset different base elements for upper and lower jaws, which then can be supplemented in modular relationship for example by different extension elements.

In a preferred embodiment the dental impression tray can be produced in respect of all or individual components substantially from a thermoplastic material which in the heated state permits forming of the impression tray in the mouth of a patient.

Further details regarding such thermoplastic trays are described in PCT application PCT/DE2018/100517—at the present time not yet published—which is to the applicant of the present PCT application and which was filed at the German Patent and Trade Mark Office as the application Office on 28 May 2018. The content of that application is to be incorporated into the present application by reference. Aspects of the impression tray of thermoplastic material in accordance with the above-identified PCT application, being aspects which appear particularly substantial for the present disclosure, are briefly described hereinafter; in respect of details attention is directed to the information set forth in the above-identified application.

In the more recent past dental materials based on low-melting thermoplastic plastics have been developed. For a limited period of time those materials permit shaping of the thermoplastic material in the mouth of the patient, approximately comparable to a plasticine. In that case the thermoplastic material can be heated in a water bath or by means of other heat sources (steam, microwave, and so forth) to relatively high temperatures of between 70° and 100° C., in which case then in practice the surface temperatures of the material in the mouth of the patient in the deformable state reach no more than typically 38° C. (an acceptable range is between 35° C. and 41° C.) and the material is then deformable at a maximum for some minutes.

The above-described plasticization process is basically reversible, that is to say the material can be repeatedly heated and deformed in the heated state. In the cooled state the material is dimensionally stable and is basically highly suitable for dental impressions.

It will be noted however that it was not known in the state of the art, how that material can be used directly for dental fine impressions in a simple practicable fashion. The main problem is that, when shapingly adapting plastic material to the patient jaw, it was usually not possible to ensure that a minimum spacing for the fine impression material is maintained between the jaw and the impression tray.

In this connection the above-identified PCT application proposes an individually adaptable impression tray for dental fine impression, wherein the impression tray is formed substantially from a thermoplastic material which in the heated state permits forming in the mouth of the patient and which is dimensionally stable in the cooled state. At least in partial regions in which a fine impression is to be effected that impression tray has a spacer layer of a predetermined thickness, wherein the spacer layer is removable after the forming operation.

The spacer layer—for example a film of a predetermined thickness—thus forms a kind of place holder for the material of the fine impression and thus also ensures that when the impression tray (with the spacer layer) is applied to the structures from which the impression is to be taken there is a defined minimum layer thickness for the fine impression material after at least partial removal of the spacer layer.

In order to ensure a reproducible position of the impression tray in the fine impression operation even without the supporting effect of the spacer layer which is then at least partially removed it can be provided in an advantageous configuration in accordance with the above-identified PCT application that the spacer layer for producing one or more so-called stops has at least one and preferably a plurality of openings, through which the thermoplastic material of the impression tray can pass directly (or closer to) to the tooth or jaw structures from which the impression is to be taken. Thus the thermoplastic material in the forming operation can pass through those openings and thus (after cooling) form fixing abutments or stops which even after removal of the spacer layer ensure a reproducible position of the impression tray so that the free space achieved by the spacer layer is uniformly available with a predetermined minimum thickness. The stops can be produced in the forming operation by virtue of the thermoplastic material passing into the openings in the spacer layer, or the stops can already be pre-formed on the impression tray and thus correspond to the openings in the spacer layer.

In accordance with the above-identified PCT application the spacer layer can project laterally beyond the impression tray in the un-adapted state thereof. By virtue of that lateral projection it is possible to ensure that the plastic material does not swell beyond the edge of the spacer layer upon adaptive forming of the thermoplastic material. At the same time the spacer layer in accordance with the modular system proposed according to the invention can thus also extend at least partially over a further fitted part of the modular system so that this would not require its “own” spacer layer although it is also possible that the parts of the modular system respectively have their “own” spacer layer.

The above-outlined concept from the specified PCT application can now be excellently well combined with the modular system according to the invention, whereby it is possible to achieve optimum adaptation of the impression tray to the patient jaw with a minimum of different components that have to be stocked.

Admittedly the thermoplastic deformability also already allows adaptation to the patient jaw. Limits are set on such deformability however, in particular if the material for that purpose has to be stretched more greatly as in that case there is the danger of “distortion” or the formation of cracks or holes. By virtue of the modular system according to the invention it is possible instead to fit additional parts prior to adaptive forming in the patient mouth or connected in some other fashion so that only minor shaping operations are required.

In that way the material thickness of the thermoplastic material can then be overall minimized. Apart from a lesser use of material, that is advantageous in particular because a thinner tray can be “heated through” more quickly in a water bath—or by means of other heat sources like steam or microwave—and that facilitates handling. Furthermore a thinner impression tray is more easily deformable and also more pleasant for the patient.

With the combination of the tray according to the above-identified PCT application and the modular system disclosed herein it is thus basically possible for all individual trays which hitherto are to be kept in readiness in the dental practice and which are also produced in a laboratory (for impressions of partially toothed jaws) and functional trays (for impressions in relation to jaws without teeth) to be replaced by only a few components. By virtue of the fact that individual or functional trays no longer have to be produced in a laboratory but can be made directly at the chair (“chairside”) the practitioner can make a saving on patient sessions and laboratory exchanges.

Even if the combination of the proposed modular system with a thermoplastic impression tray in accordance with the above-identified PCT application may be advantageous the impression tray according to the invention in an alternative configuration can also be made substantially from a non-thermoplastic material, in particular a non-thermoplastic hard plastic, silicone, a metallic material or ceramic. In this case also the modular system is found to be advantageous as the number of impression trays to be kept in stock can be markedly reduced.

In a preferred configuration the individual components of the modular system have at least one connecting means for selective connection to at least one other component. Such a connecting means can be for example in the form of a tongue and groove connection or another releasable force-locking and/or positively locking connection.

Besides the above-mentioned tongue and groove connection other pluralities of other connecting principles are also conceivable, thus for example pins (possibly also comprising another material) with corresponding openings as counterpart arrangements, elastic latching projections which latch clip-like over corresponding latching projections, magnetic connections, hook-and-loop connections, connections by means of an adhesive—which is preferably releasable again at least in the configuration phase—the use of an elastic clamp embracing all elements, and so forth.

The individual components are fixed relative to each other by the connecting means. In that case fixing in the case of using a thermoplastic material does not have to be necessarily particularly strong as heating/plasticization and subsequent shaping of the impression tray results in the components generally being intimately connected together.

In a preferred configuration the modular system has at least the following components:
at least one tray base element in one or more sizes, that is suitable both for upper jaw and also lower jaw impressions;
at least one upper jaw palate element which can be connected to the tray base element, respectively adapted to the size or the plurality of sizes of the tray base element and/or in a variant or in a plurality of variants in respect of the geometry of the curvature of the palate vault; and
at least one lower jaw lingual element which can be connected to the tray base element, respectively adapted to the size or the plurality of sizes of the tray base element.

That corresponds to the “universal” or “unisex” tray already described hereinbefore. Optionally as required that tray can be supplemented by extension elements as follows:
at least one vestibular/buccal extension element, respectively adapted to the size or the plurality of sizes of the tray base element; and/or
at least one lingual extension element, respectively adapted to the size or the plurality of sizes of the lower jaw lingual element.

In that case the extension elements can also be used fitted in multiple successive relationship to achieve greater extension.

The lingual extension elements are adapted to extend the lower jaw lingual element and are there fixed at the underside to the inner arch so that the lower jaw lingual element which is extended in that way extends further towards the lower oral cavity wall or tongue base.

The advantage of a vestibular/buccal extension element is that in this way the tray base element can also be used for impressions of jaws without teeth. Jaws without teeth not only involve a slightly different shape from the trays for toothed jaws, but in particular are considerably shorter at the edges because the corresponding teeth are missing and accordingly less height is required.

In order not to require “dedicated” base tray variants for that purpose it is possible to use the vestibular/buccal extension element. The proposed universal tray base then has a relatively short edge, that is to say even tooth-less jaws can have an impression taken therewith. In order therewith also to be able to cover (partially) toothed jaws (possibly however also tooth-less jaws) with a deep membrane fold an edge extension must be possible. For that purpose additional elements which extend the tray can be attached to the lower edge. In that case not just one additional element can be fitted, but as many as are necessary in order to provide an ideal impression.

It can also be provided that such an extension portion is already fitted in the delivery state of the base tray portion and is then only to be removed again for impressions of untoothed jaw portions, which possibly saves on working time in view of the greater frequency of taking impressions for (partially) toothed jaws.

In a preferred configuration the individual elements of the modular system at corresponding locations can further have markings and/or depressions and/or desired breaking locations which permit or simplify shortening of the impression tray for adaptation to the respective jaw aspects or for providing a partial tray.

As processing of the material—at least in the non-thermoplastic state—is not entirely simple it is appropriate to make it possible and/or to make it easier for the practitioner to shorten the tray to a correct length by virtue of depressions or desired breaking locations or at least additional markings.

For that purpose it is possible to provide in the rear portion at regular spacings, for example depressions which are disposed both buccally and occlusally at the tray base and which also continue lingually or palatinally on the additional elements.

By virtue of those depressions (recesses) the practitioner can more easily and more accurately separate off superfluous parts as the material is thinner at those locations—either with a cutter disc, a special shears tool, a special pincer tool or the like. That is to say, in the rear region he could then shorten the tray to the correct length without any problem.

In the course of further application the use of depressions does not have any adverse consequences as when the material is pressed against the jaw those locations are substantially “pressed” or equalized with the remaining wall thickness.

Overall it is preferably provided in accordance with the invention that for adaptations of the impression tray to a patient jaw, that are to be effected substantially in the direction of a vertical plane with respect to a patient jaw, that is to say upwardly or downwardly, extension elements are used, whereas for adaptations to a patient jaw, that are to be effected substantially in the direction of a saggital plane with respect to the patient jaw shortening of the impression tray is preferred. This approach involves a base element of the impression tray being rather of a short configuration in respect of its extent in the vertical plane (apart from possibly “pre-fitted” extensions) so that no shortenings, but normally only extensions, are required, and conversely in regard to the extent in a saggital plane in particular in regard to the length of the tray arch—it is rather “excessively long” so that no extensions but normally only shortenings are required.

According to the invention there is further proposed a component for a dental impression tray. The component is adapted for use for a dental impression tray as described hereinbefore and for that purpose has in particular at least one connecting element adapted for selective connection to at least one other component of the dental impression tray. The connection can be made in the most widely varying ways, for example by way of a tongue and groove connection or another force-locking or positively locking connection, as described hereinbefore.

There is further proposed a method of providing a patient jaw-adapted dental impression tray comprising at least partially a thermoplastic material, which has at least the steps:
a) configuration of the impression tray from at least two components which are part of a modular system for the dental impression tray corresponding to the patient jaw situation and connection of the components;
b) if required shortening of components;
c) heating of the impression tray; and forming, as well as cooling; and
d) providing the impression tray for fine forming in the patient jaw or for fine forming to a jaw model in a dental laboratory.

In that way it is then possible either to implement the fine impression as described in greater detail in PCT application PCT/DE2018/100517. Alternatively that method, as indicated in step d), can also be used in a dental laboratory for the production of impression trays on the basis of a gypsum model of the patient jaw.

An important advantage of the invention—irrespective of whether it is implemented with a thermoplastic material or without—is that many tray variants become superfluous and a high saving potential can be achieved and at the same time also it is possible to attain more individual supply for the patient than with a ready-made tray.

By means of the invention it is further possible to avoid the situation where the practitioner or the chair assistant does have the correct tray or that possibly even a tray has to be forcibly bent so that it approximately “fits”.

More accurate fitment of the tray also has a better result in terms of making the impression.

Furthermore the additional elements take up less space and the practitioner does not require the number of tray bases, that he requires when using the conventional trays, as the new tray bases are multi-functional.

The invention is described in greater detail hereinafter by means of the embodiments by way of example illustrated in the drawings in which:

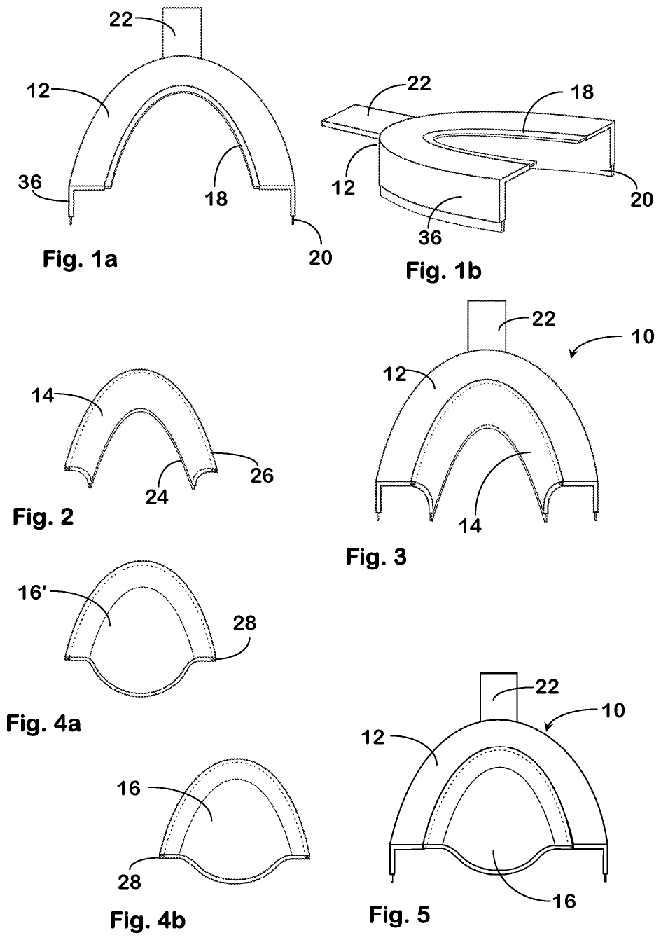

FIGS. 1a and b show diagrammatic views of an embodiment for a tray base element without inserted further parts,

FIG. 2 shows a diagrammatic view of an embodiment of a lower jaw lingual element,

FIG. 3 shows a diagrammatic view of a tray base element as shown in FIGS. 1a and b with inserted lower jaw lingual element as shown in FIG. 2,

FIGS. 4a and b show diagrammatic views of embodiments for an upper jaw palatal element in two variants for different palate geometries,

FIG. 5 shows a diagrammatic view of a tray base element as shown in FIGS. 1a and b with inserted upper jaw palatal element as shown in FIG. 4b,

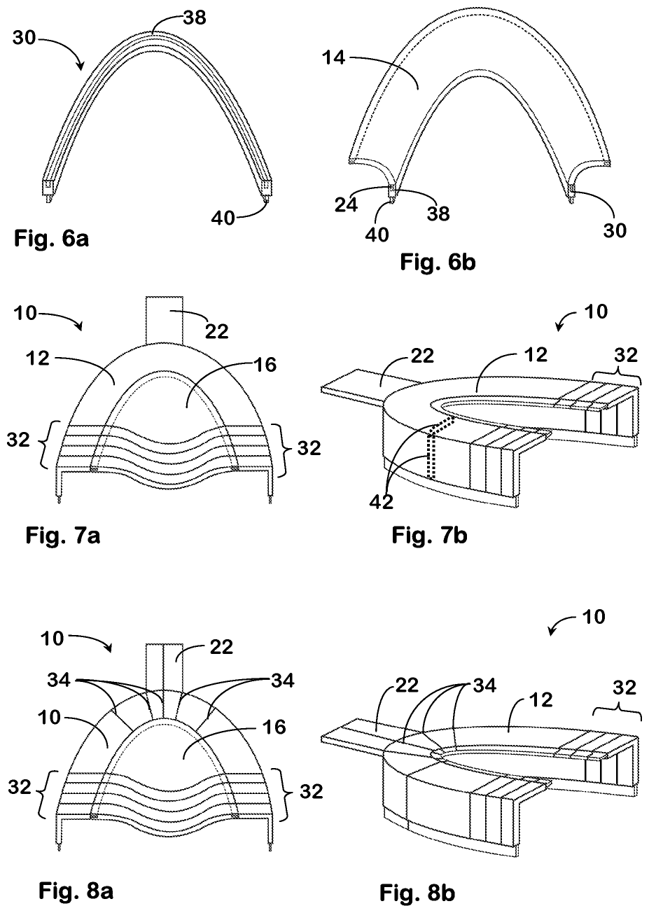

FIG. 6a shows an embodiment for an extension element for a lower jaw lingual element,

FIG. 6b shows a diagrammatic view of a lower jaw lingual element as shown in FIG. 2 with attached extension element as shown in FIG. 6a,

FIGS. 7a and b show diagrammatic views of embodiments for a tray base element with inserted upper jaw palatal element and end depression grooves/desired breaking lines to simplify shortening for jaw-individual length adaptation,

FIGS. 8a and b show diagrammatic views similar to FIGS. 7a and b in which moreover additional depression grooves/desired breaking lines are shown, by means of which partial trays can be separated off, and

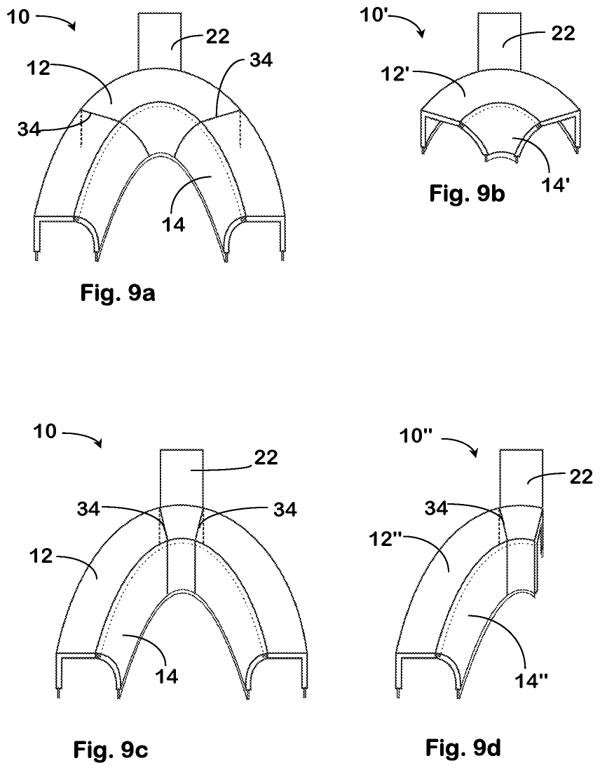

FIGS. 9a-d show examples for forming partial trays.

FIGS. 1a and 1b show diagrammatic views of an embodiment for a tray base element 12 according to the invention, which can be used universally both for upper jaw and also lower jaw impressions.

As can be seen the “internal space” is kept free and of the originally known trays only the buccal and occlusal wall 36 is incorporated as well as a tray handle 22. The base tray element 12 dispenses with the “fixed” provision of a lingual or palatinal component.

Instead there is a fixing element 18 (in particular a tongue of a tongue and groove connection) for the selective use of various “add-ons”, more specifically either a lower jaw lingual element 14 or an upper jaw palatal element 16, 16′.

A further fixing element, also a tongue 20 of a tongue and groove connection, is provided at the lower end edge of the buccal and occlusal wall 36, which serves to fit optional extension elements, as is described hereinafter.

The corresponding insert elements, that is to say the lower jaw lingual element 14 and the upper jaw palatal element 16, 16′ which are shown in themselves in FIG. 2 and in FIGS. 4a and 4b respectively have corresponding counterpart fixing elements (grooves 26 and 28 respectively) and can thus be inserted with an accurate fit into the free inner arch of the base element 12 and fixed thereto.

In that way, as shown in FIG. 3 (illustrating the combination of tray base element 12 and lower jaw lingual element 14) and FIG. 5 (combination of tray base element 12 and upper jaw palatal element 16) an impression tray as denoted overall by reference 10 is pre-configured in patient-individual fashion.

By virtue of differing sizes for the tray base element 12 the tray 10 can thus be matched as closely as possible to the jaw geometry of the patient, which is both more pleasant to the patient and can also provide for better impression.

In spite of different size variants (not shown) of the base element 12 it can be provided that the inner arch is always of the same shape with the fixing tongue 18 so that it is possible to use respectively identical lower jaw or upper jaw elements 14, 16, and that reduces the number of parts to be stocked.

In regard to the lower jaw or upper jaw elements it is found to be desirable for the upper jaw palatal element to be provided in at least two geometrical variants 16, 16′ so that adaptation to different palatal configurations (shallow/deep palates) is possible.

Various extension elements can be provided as a further element with which the tray 10 can be modified and thus the number of tray models to be stocked can be reduced.

FIG. 6a shows diagrammatically and not true to scale an extension element 30 for the lower jaw lingual element 14, with the tongue 24 of which it can be connected by way of a groove 38 so that the lower jaw lingual element extends further on to the tongue base. If that extension is not sufficient then a further similar extension element 30 can be fitted by way of a further fixing tongue 40 on the extension element 30, and so forth.

The extension element shown in FIG. 6a can also be used in a somewhat different geometrical configuration—not explicitly shown here—for extending the buccal and occlusal wall 36 of the tray base element 12. For that purpose a corresponding element (as mentioned, not explicitly shown but similar to FIG. 6a) is fitted into the tongue 20 of the tray base element 12. As already mentioned, that extension permits use of the tray base element 12 both for untoothed and toothed jaws, by the tooth height-governed difference being compensated by suitable extension elements.

The principle described up to this point is basically possible for all current materials. It is already possible thereby to provide that many tray variants become redundant and a high saving potential is achieved, whereby at the same time it is also possible to achieve more individual provision for the patient than with a prefabricated tray.

In that way it is possible to avoid the practitioner or the chair assistant missing the correct tray, or possibly even a tray having to be forcibly bent so that it fits to some extent. More accurate fitment of the tray also provides for a better result in making the impression. Furthermore the additional elements take up less space and the practitioner does not require the number of tray bases that he needs when using the original trays as the tray bases according to the invention are multifunctional.

In connection with a thermoplastic configuration of the tray, as is described hereinbefore or in the above-mentioned PCT application, there are still further available options for more effectively implementing that concept.

In addition when involving a thermoplastic configuration some special additional aspects are also to be noted, in particular the use of a film and the use of notches/separating grooves/separating lines/separating markings.

A further reduction in the variants to be stocked can be achieved with a thermoplastic material. With for example “conventionally” four different tray sizes it is now possible to omit three tray sizes, more specifically by virtue of the material properties in the heated state.

If conventionally tray size “1” is the smallest and tray size “4” represents the largest a base tray comprising a thermoplastic material can be for example tray size “3”. The tray sizes “1” and “2” are then redundant because the tray size “3” can be shaped in such a way that it satisfies the tray sizes “1” and “2”.

Correspondingly tray size “4” can be omitted as tray size “3” in the heated state can be enlarged to give tray size “4”.

In other words, if previously (in the above-described configuration using conventional materials) at least four tray sizes per jaw were still required it is now only still one plus additional components for both jaws.

In addition this form of the tray preferably represents a one-off part, the costs of which the practitioner could put on the patients. In addition this means that no single tray then has to be cleaned and sterilized or re-ordered (hygiene advantage).

Furthermore there is the option of easily recycling the product so that it is possible to save on resources. Alternatively it is also possible to use a thermoplastic which is biologically degradable.

With this variant also it is advisable to fit a film as a spacer to the tray base element 12 (this is not shown in the drawings) as described hereinbefore or in the above-indicated unpublished PCT application. Accordingly the additional elements 14, 16 and possibly 30 should then also include the corresponding film insofar as the film of the base element 12 is not of such a large protrusion that it also involves the additional parts.

The practitioner therefore has the option, as already described in the above-identified application, of directly manufacturing an individual tray/functional tray, which otherwise is only possible in the laboratory, and accordingly to provide ideal conditions for making an impression and markedly reducing the number of patient sessions required.

It is thus conceivable that the described impression system permits more effective work and thus sets new standards in terms of quality and economy by virtue of the increase in the “chairside” components of the processes, reduction in the number of treatment sessions required, reduction in courier journeys and overall the reduction in process steps and the elimination that this entails of possible sources of error.

The above-described tray can also be used for the production of individual trays and functional trays in the laboratory, that is to say the technician pre-individualizes the tray (possibly by cutting off or fitting material components), heats it and shapes it to a gypsum model of a patient jaw, that he has previously produced. Those trays can then in turn be used by the practitioner for obtaining fine impressions.

Preferably the tray base element 12 should be relatively long towards the rear/distal part (extended) so that it is possible to deal with almost every patient situation by performing shortening operations, as described in greater detail hereinafter:

As processing of the material is not generally simple it is possible to make it easier for the practitioner to shorten the tray to the correct length by an “additional element”/or some “additional markings”.

For that purpose, as shown in FIGS. 7a, b and 8a, b, for example depressions/grooves 32 are preferably provided in the rear part at regular spacings, which are disposed both buccally and occlusally on the tray base 32, and also extend lingually and palatinarly respectively to the additional elements. In the drawings, FIG. 7a and FIG. 8a respectively show the combination of a tray base element 12 and an upper jaw palate element 16 while FIGS. 7b and 8a only show the tray base element 12.

By virtue of those “depressions” (recesses)/grooves 32 the practitioner can more easily and more precisely cut off excess parts as the material is thinner at those locations. Separation can be effected with a cutting disc, a special shears tool, a special pincer tool, by “nipping off” or in a similar fashion. In other words in the rear region he can then shorten the tray to the correct length without any problem. The use of recesses does not have any adverse consequences in the further proceedings as when the material is pressed against the jaw those locations are “pressed” with the other wall thickness.

The grooves 32 can be of a depth of about 50%-90%, preferably about 30% of the overall material thickness. In FIG. 7b reference 42 also indicates by means of dotted lines that, instead of grooves, it is also possible to provide complete openings/gaps (shown in exaggerated width in FIG. 7b), and they can then however preferably extend only over a partial region of the cross-section. That allows the corresponding parts possibly to be broken off “by hand” or possibly with the aid of suitably adapted tools which engage into the openings. Alternatively perforation-like desired breaking locations are also conceivable.

In addition such recesses (and to a certain extent guide lines) can also be used in other ways in order to provide the practitioner with accurate markings for producing a partial tray. The corresponding “desired breaking locations” are marked or predetermined by the grooves/depressions 34 shown in FIGS. 8a, b. Thus the practitioner can very quickly produce a partial tray from an “entire tray”, as can be seen from FIGS. 9a-d.

In that respect FIGS. 9a and 9b illustrate the production of a partial tray 10′ (with correspondingly shortened elements 12′, 14′) for taking an impression in the front tooth area.

FIGS. 9c and 9d illustrate production of a partial tray for taking an impression in the lateral tooth area for quadrants 1 and 3 (tray 10″ comprising the components 12″, 14″). If the other side were cut off that would give a partial tray for the quadrants 2 and 4.

Alternatively it would also be possible to integrate complete free areas (“notches”) into the tray 10, that is to say corresponding gaps are integrated into the tray, in which case the mechanical integrity of the tray is only ensured by connected regions laterally of the gaps. In that case it would be possible to simply break away the regions to be removed. The gaps would then disappear in the heated state upon pressing of the main body.

In an alternative embodiment it would also be possible to be limited to colored markings in order to make exclusively a separation aid available to the practitioner.

Possible Example of Implementation for a Modular System for a Thermoplastic Impression Tray:

In an example a total of six elements are sufficient for each patient and each impression variant (mucodynamic or mucostatic):
the developed tray base of size 3 (=1 part)
vestibular/buccal extension element (=1 part)
upper jaw palate element in two variants (=2 parts)
lower jaw lingual element (=1 part)
extension element lingual (=1 part).

All elements are ideally provided with a film as a spacer in accordance with PCT/DE2018/100517.

Proceedings in the Chair (Non-Thermoplastic Materials):
the practitioner picks out the right size of base tray;
he now fixes the necessary additional element for distinguishing the upper jaw and the lower jaw;
checking of the edge length—optionally effecting tray extension with additional elements;
fresh checking of the produced tray in the mouth of the patient;
if all is in order—IMPRESSION.

Proceedings in the Chair (Thermoplastic Materials)
the practitioner picks out the right size of base tray;
he now fixes the necessary additional element for distinguishing the upper jaw and the lower jaw;
checking of the edge length—optionally effecting tray extension with additional elements;
if the tray is distally too long the practitioner can quickly shorten the tray produced by means of the depressions/notches/gaps/markings or, if desired, reconfigure the tray as a partial tray;

Now the tray is heated and the progression is as described in PCT/DE2018/100517, that is to say:
adaptive forming of the heated tray in the mouth of the patient, wherein the spacer film defines the space for the later fine impression and keeps it clear and “stops” (these are formed either in the adaptive forming operation or are already pre-shaped) ensure the defined position of the impression tray in the jaw even after later removal of the spacer film, in that case in general the individual components of the modular system are also intimately connected together so that they can no longer be readily detached and unnecessary grooves/gaps are more or less equalized;
taking out the tray and removing the spacer layer;
optionally introducing a bonding agent;
introducing a runny impression material for the fine impression, and
effecting fine impression in the mouth of the patient.

1. A dental impression tray characterised in that the impression tray can be assembled in a modular system from a plurality of parts or components which can be connected together and is thus adaptable individually to the patient jaw situation.

2. A dental impression tray as set forth in claim 1 has further comprising a base tray which can be used equally for lower and upper jaws and which can be respectively supplemented and/or adapted by connectable additional parts.

3. A dental impression tray as set forth in claim 1 wherein all or individual components are substantially produced from thermoplastic material which in a heated state permits forming of the impression tray in the mouth of a patient.

4. A dental impression tray as set forth in claim 3 wherein a material thickness of the thermoplastic material is minimized in such a way that adaptations to given patient jaw situations are achieved not by mere forming of the thermoplastic material but only by use of additional parts.

5. A dental impression tray as set forth in claim 3 wherein at least in partial regions in which fine impression is to be implemented the impression tray has a spacer layer of a predetermined thickness, wherein the spacer layer is completely or partially removable after the forming operation.

6. A dental impression tray as set forth in claim 1 wherein it substantially comprises a non-thermoplastic material.

7. A dental impression tray as set forth in claim 1 wherein the individual components have at least one connecting means for selective connection to at least one other component.

8. A dental impression tray as set forth in claim 7 wherein the at least one connecting means is in the form of a tongue and groove connection or another releasable positively locking and/or force-locking connection.

9. A dental impression tray as set forth in claim 1 wherein the modular system has at least the following components:
at least one tray base element in one or more sizes, that is suitable both for upper jaw and also lower jaw impressions;
at least one upper jaw palate element connectable to the tray base element, respectively adapted to the size or the plurality of sizes of the tray base element and/or in a variant or in a plurality of variants in respect of the geometry of the curvature of the palate vault; and
at least one lower jaw lingual element connectable to the tray base element, respectively adapted to the size or the plurality of sizes of the tray base element.

10. A dental impression tray as set forth in claim 9 wherein the modular system further has one or more of the following components:
at least one vestibular/buccal extension element, respectively adapted to the size or the plurality of sizes of the tray base element; and/or
at least one lingual extension element, respectively adapted to the size or the plurality of sizes of the lower jaw lingual element.

11. A dental impression tray as set forth in claim 10 wherein the extension elements are so adapted to be used in multiple successive relationship to achieve greater extensions.

12. A dental impression tray as set forth in claim 1 wherein the individual elements of the modular system at corresponding locations have markings and/or depressions and/or desired breaking positions which permit and/or simplify shortening of the impression tray for adaptation to the respective jaw aspects or to create a partial tray.

13. A dental impression tray as set forth in claim 1 wherein
extension elements are provided for adaptations to a patient jaw, that are to be effected substantially in the direction of a vertical plane with respect to the patient jaw, and
shortenings of the impression tray towards dorsal are provided for adaptations to a patient jaw, that are to be effected substantially in the direction of a saggital plane with respect to the patient jaw.

14. A dental impression tray as set forth in claim 1 substantially comprising a non-thermoplastic hard plastic, silicone, a metallic material, or ceramic.

15. A dental impression tray, comprising:
a modular system comprising a plurality of connectable parts or components capable of being assembled to form the dental impression tray and individually adaptable to a patient jaw situation.
